(19) United States
(12) Patent Application Publication
(10) Pub. No.: US 2015/0266616 A1
(43) Pub. Date: Sep. 24, 2015

(54) STACKED SHIPPING CONTAINER ASSEMBLY AND METHOD THEREOF

(71) Applicant: Three Squared, Inc, Detroit, MI (US)

(72) Inventors: Ross Barrable, Pagosa Spgs, CO (US); Dan Morris, Pagosa Spgs, CO (US)

(21) Appl. No.: 14/219,220

(22) Filed: Mar. 19, 2014

(51) Int. Cl. B65D 21/02; B23K 31/02; B65D 88/02

(52) U.S. Cl. CPC B65D 21/0215; B65D 88/022; B23K 31/02

(57) ABSTRACT

There is a stacked shipping container assembly having a bottom shipping container including a plurality of corner blocks at top corners thereof. The stacked shipping container assembly includes a top shipping container having a plurality of corner blocks at bottom corners thereof. The top shipping container is stacked on the bottom shipping container wherein at least two of the corner blocks of each of the bottom shipping container and the top shipping container are aligned horizontally with each other. The stacked shipping container assembly includes a pair of stacking cones each disposed between horizontally aligned pairs of corner blocks. The assembly includes a pair of toroidal weld plates each disposed around a corresponding stacking cone and between horizontally aligned pairs of corner blocks.

### BACKGROUND OF THE INVENTION

1. Field of the Invention

The present invention relates to stacking cones for shipping containers, specifically to a stacking cone assemblies, systems, kits and methods of stacking shipping containers.

2. Description of the Related Art

A shipping container is a container with strength suitable to withstand shipment, storage, and handling. Shipping containers range from large reusable steel boxes used for intermodal shipments to the ubiquitous corrugated boxes. In the context of international shipping trade, “container” or “shipping container” is virtually synonymous with “(standard) intermodal freight container” (a container designed to be moved from one mode of transport to another without unloading and reloading).

Freight containers are a reusable transport and storage unit for moving products and raw materials between locations or countries. There are approximately seventeen million intermodal containers in the world; a large proportion of the world's long-distance freight generated by international trade is transported in shipping containers. Their invention made a major contribution to the globalization of commerce in the second half of the 20th century, dramatically reducing the cost of transporting goods and hence of long-distance trade.

An intermodal container (also container, freight container, ISO container, shipping container, hi-cube container, box, conex box and sea can) is a standardized reusable steel box used for the safe, efficient and secure storage and movement of materials and products within a global containerized intermodal freight transport system. “Intermodal” indicates that the container can be moved from one mode of transport to another (from ship, to rail, to truck) without unloading and reloading the contents of the container.

A typical container has doors fitted at one end, and is constructed of corrugated weathering steel. Containers were originally 8 feet wide by 8.5 feet high, and either a nominal 20 feet or 40 feet long. They could be stacked up to seven units high. At each of the eight corners are corner block castings with openings for fasteners and/or stacking cones. The coupling holes are all female and it generally takes a double male insert to mate container stacks together.

Some improvements have been made in the field. Examples of references related to the present invention are described below in their own words, and the supporting teachings of each reference are incorporated by reference herein:

U.S. Pat. No. 7,059,488, issued to Myers, discloses an apparatus and method are disclosed for removably attaching an ISO corner fitting to a composite material shipping container. The apparatus and method of the invention comprises a post that is anchored in the composite material frame of the container. The ISO corner fitting is then attached to the post using a connector assembly that may be engaged and disengaged as needed to attach and detach the ISO corner fitting from the post. The post has a plurality of grooves formed thereon that help hold the post in the composite material of the shipping container. The grooves transfer any tension or compression loads that are applied to the ISO corner fitting directly to the shipping container.

U.S. Pat. No. 7,114,898, issued to Brewster, discloses a cargo container hold down device that includes a housing defined by a base which forms a planar surfacing thereabout on which cargo container corner fittings results in the applied relation on the container relative to the supporting structure or platform involved. The hold down device includes a flanged end which engages a cargo container corner casting aperture opening or an appropriate aperture and utilizes the structure for retention of the hold down device so the opposite side of the hold down device is allowed to automatically engage and disengage with a cargo container corner fitting as necessary to achieve proper handling and transport of cargo containers.

U.S. Pat. No. 7,896,593, issued to Brewster, discloses an improved cargo container securement device includes a housing defined by a base which forms a planar surfacing thereabout on which cargo container corner fittings rest in applied relation on the container relative to the supporting structure or platform involved. The container securement device includes a flanged end which engages a cargo container corner casting aperture opening or an appropriate aperture and utilizes the structure for retention of the securement device so the opposite side of the hold down device is allowed to automatically engage and disengage with a cargo container corner fitting as necessary to achieve proper handling and transport of cargo containers. The hold down device includes an indicator to visually signal that the automatic hold down feature of the device is engaged or disengaged with a cargo container corner fitting of cargo containers.

U.S. Pat. No. 8,458,861, issued to Ostberg, discloses a coupling device for coupling containers includes a body part having a fastening piece and a cam part on upper and lower parts thereof, and a planar coupling plate between the upper and lower parts. The fastening piece is fastenable to an upper corner piece in a corner of a container by rotating the body part around its vertical axis. The cam part controls the motion of the body part and receives substantially vertical forces between the containers. The body part includes a first rotating locking part for preventing and/or releasing the motion of the body part, and a second rotating locking part for enabling and/or preventing lateral motion of the body part. The second locking part is in direct or indirect contact with the first locking part so that when the first locking part rotates, the second locking part also rotates, enabling a locking mode or an unlocking mode.

U.S. Pat. No. 7,942,282, issued to Hung, discloses a retainer for securing together upper and lower shipping containers includes interconnected upper and lower retaining members each adapted to be inserted into a hole in a corner piece of a respective one of the upper and lower shipping containers, and at least one swing member disposed inside the lower retaining member. The upper retaining member has a top end aligned with a bottom end of the lower retaining member along an axial line of the retainer. The swing member includes a lower pivot portion connected pivotally to the lower retaining member, and an upper engaging portion which is proximate to the axial line in a non-engaging position and when the axial line of the retainer is substantially vertical, and which moves away from the axial line in an engaging position when the axial line of the retainer is inclined and non-vertical.

The inventions heretofore known suffer from a number of disadvantages which include being unsafe, being ineffective, being inefficient, being difficult to use, being limited in application, being complex to use, being bulky, being stacked safely, being not aligned, being difficult to align, being slow to utilize/install, not providing accurate relative container placement, requiring manual adjustment for vertical alignment, not serving multiple purposes and the like and combinations thereof.

What is needed is a stacked shipping container assembly, kit, method and/or the like that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available shipping container assemblies. Accordingly, the present invention has been developed to provide a safe and effective stacked shipping container assembly.

According to one embodiment of the invention, there is a stacked shipping container assembly. The assembly may include a bottom shipping container that may have a plurality of corner blocks at top corners thereof. The stacked shipping container assembly may include a top shipping container that may have a plurality of corner blocks at bottom corners thereof. The top shipping container may be stacked on the bottom shipping container wherein at least two of the corner blocks of each of the bottom shipping container and the top shipping container may be aligned horizontally with each other.

The stacked shipping container assembly may include a pair of stacking cones each may be disposed between horizontally aligned pairs of corner blocks. The assembly may include a pair of toroidal weld plates each may be disposed around a corresponding stacking cone and between horizontally aligned pairs of corner blocks. The pair of toroidal weld plates may be of substantially the same height. The assembly may also include a weld that may be fixedly coupling aligned corner blocks to their associated weld plates.

The pair of toroidal weld plates may have flat top and bottom surfaces. The pair of toroidal weld plates may have exterior sides shaped and sized to be flush with exterior sides of corresponding corner blocks. The pair of stacking cones may be pyramidal shaped. The stacking cones each may rest within the corresponding corner block.

According to one embodiment of the invention, there is a shipping container stacking kit. The kit may include a stacking cone that may have a top connector shaped to penetrate a corner block hole. The stacking cone may include a bottom connector that may be shaped to penetrate a corner block hole. The stacking cone may include a medial region that may be coupling the top connector to the bottom connector. The kit may include a toroidal weld plate that may have an inner hole that may be shaped and sized to receive the medial region of the stacking cone. The toroidal weld plate may include flat top and bottom surfaces.

The shipping container stacking kit may include a second stacking cone and an associated second toroidal weld plate. The toroidal weld plate may have exterior sides shaped and sized to be flush with exterior sides of standard shipping container corner blocks. The top and bottom connectors may be pyramidal shaped. The inner hole of the toroidal weld plate may be disposed substantially off-center to the toroidal weld plate.

According to one embodiment of the invention, there is a method of stacking shipping containers. The method may include the step of placing a pair of stacking cones each disposed between horizontally aligned pairs of corner blocks of a first shipping container. The method of stacking shipping containers may include the step of placing a toroidal weld plate about each of the pair of stacking cones and on top of the pairs of corner blocks. The method may include placing a second shipping container over the stacking cones such that the stacking cones penetrate into holes of corner blocks of the second shipping container. The method may include the step of welding the corner blocks together via the toroidal weld plates.

The method of stacking shipping containers may include the step of leveling the second shipping container with respect to the first shipping container. The method may include the step of aligning the toroidal weld plates with outer edges of their respective corner blocks. The method of stacking shipping containers may include the step of placing a pair of stacking cones each disposed between horizontally aligned pairs of top corner blocks of the second shipping container. The method may include the step of placing a toroidal weld plate about each of the pair of stacking cones and on top of the pairs of corner blocks. The method may include placing a third shipping container over the stacking cones such that the stacking cones penetrate into holes of corner blocks of the third shipping container. The method of stacking shipping containers may include welding the corner blocks together via the toroidal weld plates.

According to one embodiment of the invention, there is a stacking cone assembly. The assembly may consist of a stacking cone that may have a top connector that may be shaped to penetrate a corner block hole. The stacking cone may include a bottom connector that may be shaped to penetrate a corner block hole. The stacking cone may also include a medial region that may be coupling the top connector to the bottom connector. The assembly may include a toroidal weld plate that may have an off-center inner hole that may be shaped and sized to receive the medial region of the stacking cone and may have flat top and bottom surfaces. The plate may be disposed about the medial region of the stacking cone. The toroidal weld plate may have exterior sides that may be shaped and sized to be flush with exterior sides of standard shipping container corner blocks. The toroidal weld plate may be welded to a pair of adjacent corner blocks of stacked shipping containers.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a perspective view of a stacked shipping container assembly, according to one embodiment of the invention;

FIG. 2 is an exploded perspective view of a stacked shipping container assembly, according to one embodiment of the invention;

FIG. 3 is partial cross-sectional side-elevational view of a stacked shipping container assembly, according to one embodiment of the invention;

FIG. 4 is a perspective view of a shipping container stacking kit, according to one embodiment of the invention;

FIG. 5 is an exploded view of a shipping container stacking kit, according to one embodiment of the invention;

FIG. 6 is a perspective view of a stacking cone coupled to a shipping container, according to one embodiment of the invention;

FIG. 7 is a perspective view of a toroidal weld plate and a stacking cone coupled to a shipping container, according to one embodiment of the invention;

FIG. 8 is a perspective view of a stacking cone, according to one embodiment of the invention;

FIG. 9 is a top plan view of a toroidal weld plate, according to one embodiment of the invention; and

FIG. 10 is a flow chart of a method of stacking shipping containers, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

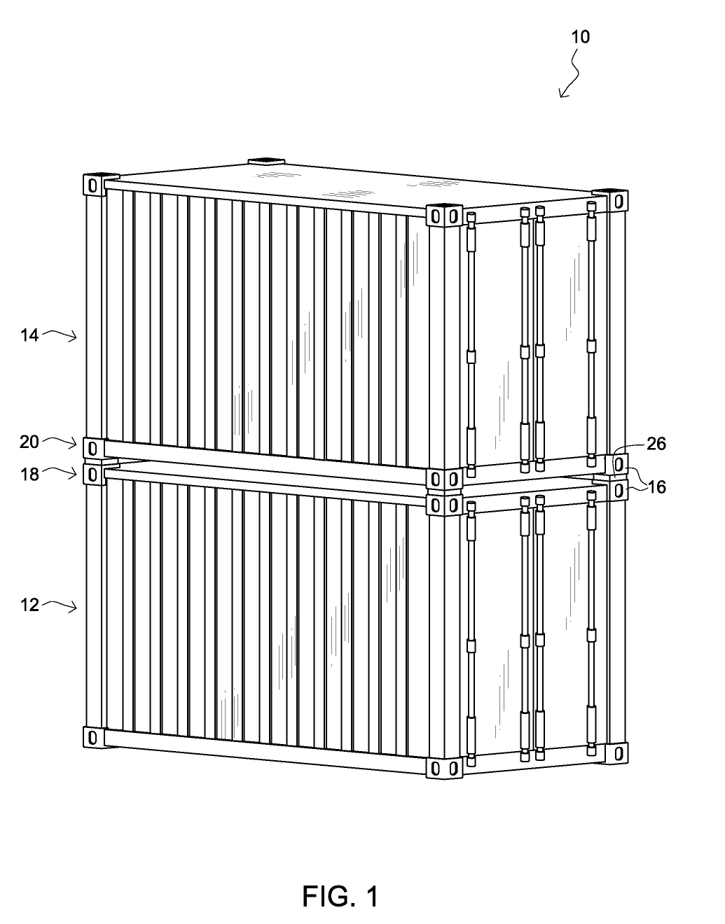

FIG. 1 is a perspective view of a stacked shipping container assembly, according to one embodiment of the invention. There is shown a stacked shipping container assembly 10 including a bottom shipping container 12 and a top shipping container 14 each including a plurality of corner blocks 16. The illustrated stacked shipping container assembly 10 is configured to couple a plurality of shipping containers together. This assembly is particularly useful when constructing buildings out of shipping containers. The stacked shipping container assembly 10 is configured to eliminate axial or lateral movement once welded into place and to provide automatic alignment before welding.

The assembly 10 includes a bottom shipping container 12 having a plurality of corner blocks 16 at top corners 18 thereof. The corner blocks 16 are securely coupled to the top corners 18 of the shipping container 12. Such corner blocks include female receptacles or apertures/holes therethrough for mating with stacking cones and/or other devices intended to mate therewith. Though not illustrated, the bottom shipping container may also include corner blocks on the bottom thereof.

The stacked shipping container assembly 10 also including a top shipping container 14 having a plurality of corner blocks 16 at bottom corners 20 thereof. The corner blocks are securely coupled to the bottom corners 20 of the shipping container 14. The illustrated top shipping container 14 is stacked on the bottom shipping container 12 wherein at least two of the corner blocks 16 of each of the bottom shipping container 12 and the top shipping container 14 are aligned horizontally with each other. In the illustrated example, the shipping containers are signed and aligned such that the entirety of the top shipping container is over the entirety of the bottom shipping container such that there is no overhang. The illustrated assembly 10 includes a weld 26 fixedly coupling aligned corner blocks 16 to associated weld plates. Though not illustrated, the top shipping container may also include corner blocks on the top thereof.

According to one embodiment of the invention, the stacked shipping container assembly 10 is configured to provide a fast and exact alignment when stacking 20′, 40′ or other sized shipping containers on top of each other for the purpose of creating modular container building structures. The stacking flange (weld plate) positions and aligns the corner blocks of the shipping containers on top of each other so the containers can be connected together with a greater structural strength than would be without. (See generally ISO regulation 1161-1984(E)(4)).

The stacked shipping container 10 includes a flange, or a weld plate, that extends out to the edge of the corner block on the two outer exposed surfaces of the corner block as the containers are stacked and provides a clean and accessible weld plate to permanently join or weld the top and bottom corner blocks of staked shipping containers together. In addition, the flange works in conjunction with a stacking cone, such as but not limited to model number BC-A3/C provided by Pacific Marine and Industrial, which includes a shear strength of 420 KN thus providing an added function of time tested vertical stability that complies with the specifications for earthquake tremors using multi-level container construction.

In one non-limiting embodiment, there is a flattened rectangular toroid alignment flange/weld plate that is shaped to allow for precise alignment of shipping containers in the stacking sequence for modular housing. It couples to existing stacking cones that are readily available to any customer. Through this coupling, it precisely and/or accurately positions them within a coupled corner block access port in such a way that when the next container is set on top it is automatically self-aligned. The flange extends to the edges of the coupled corner blocks and thereby provides a bridge between the two over which a weld may be placed. Such functions as an alignment tool and connection hardware all in one simple structure.

Advantageously, the flange/weld plate when used in conjunction with a stacking cone is able to facilitate the stacking of shipping containers during building construction, wherein the stacked shipping containers are used in building the framework of the building. Such a flange advantageously reduces the time required to properly stack such containers, reduces the costs of construction, increases the alignment of such containers, is easy to store and install, and/or is easily adjusted for various corner block/stacking cone shapes, sizes and mating structures. Further, the flange is easy to manufacture, inexpensive (especially in relation to the direct financial benefits it provides), is durable, and easy to ship/store.

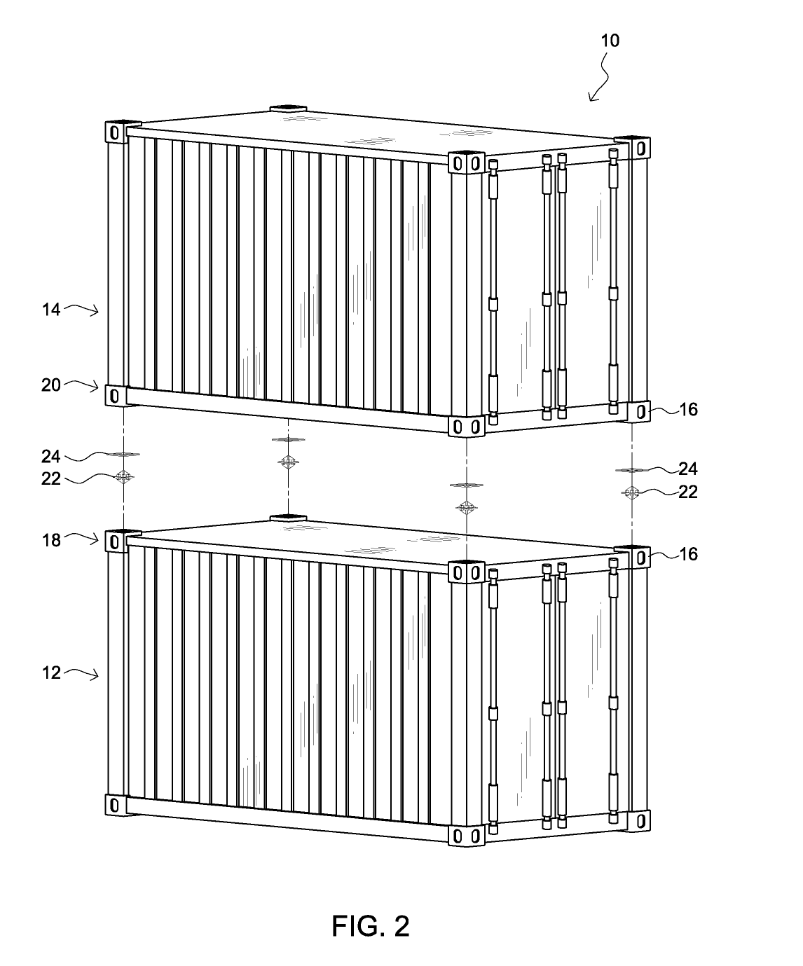

FIG. 2 is an exploded view of a stacked shipping container assembly, according to one embodiment of the invention. There is shown a stacked shipping container assembly 10 including a bottom shipping container 12, a top shipping container 14, a pair of stacking cones 22, and a pair of toroidal weld plates 24.

The illustrated stacked shipping container assembly 10 includes a bottom shipping container 12 having a plurality of corner blocks 16 at top corners 18 thereof. The stacked shipping container assembly 10 includes a top shipping container 14 having a plurality of corner blocks 16 at bottom corners 20 thereof. The top shipping container 14 is stacked on the bottom shipping container 12 wherein at least two of the corner blocks 16 of each of the bottom shipping container 12 and the top shipping container 14 are aligned horizontally with each other.

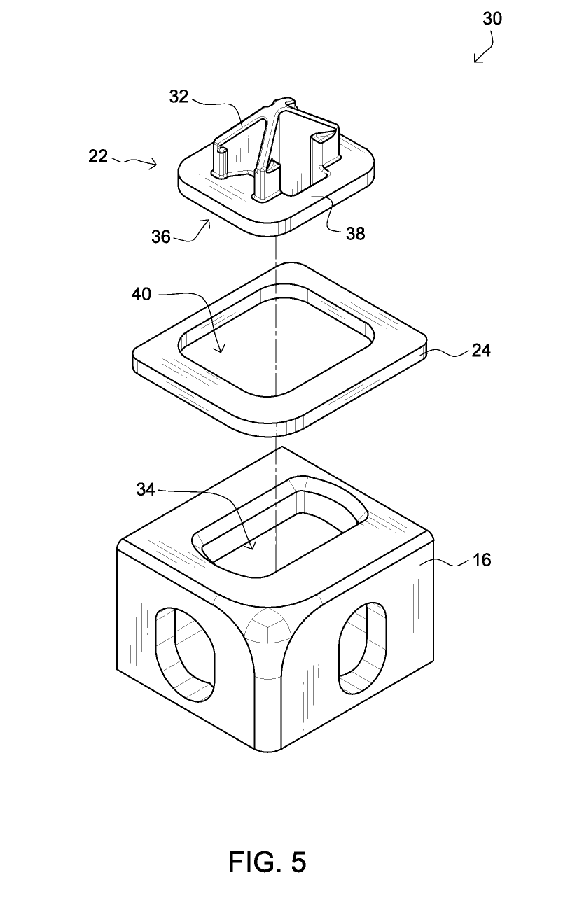

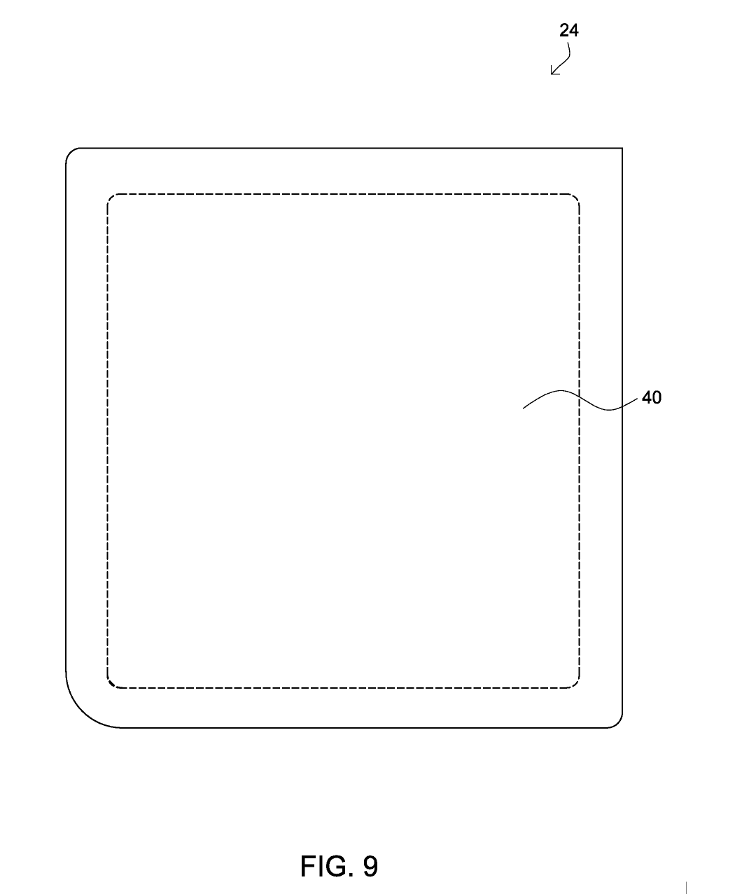

The stacked shipping container assembly 10 includes a pair of stacking cones 22 each disposed between horizontally aligned pairs of corner blocks 16. The stacking cone 22 is configured to rest within a hole or aperture of the corner block 16, thereby aligning the top shipping container 14 with the bottom shipping container 12 for storage or transportation. The assembly 10 includes a pair of flattened-rectangular-toroidal weld plates 24 each disposed around a corresponding stacking cone 22 and between horizontally aligned pairs of corner blocks 16. The flange/weld plates are of a material (e.g. steel) that is suitable for welding to. As used herein a toroidal shape includes a “ring” having a “hole” therethrough which is not necessarily circular (or even an ellipsoid or regular polygon) and the “ring” may be irregularly shaped and is not necessarily formed by rotation of a single ellipsoid or regular polygon, but may be of different shapes/sizes about the rotation (See generally FIGS. 5 and 9).

The pair of toroidal weld plates 24 include exterior sides shaped and sized to be approximately flush with exterior sides of corresponding corner blocks 16, sufficiently so such that an appropriate weld may be formed across the weld plate between the adjacent corner blocks. The pair of stacking cones 22 are pyramidal shaped. The stacking cones 22 each may rest within the corresponding corner block 16.

According to one embodiment of the invention, there is an alignment flange or a weld plate designed to allow for precise alignment of shipping containers in the stacking sequence for modular housing. The stacked shipping container assembly uses existing stacking cones to precisely and accurately position them within corner block access ports of the shipping container, in such a way that when another container is set on top of the other, the assembly automatically self-aligns within about any of ⅛, 1/16, 1/32, 1/64, and/or 1/128 of an inch of vertical alignment on one or more axis. The stacking cone and weld plate functions as an alignment tool and connection hardware all in one simple invention.

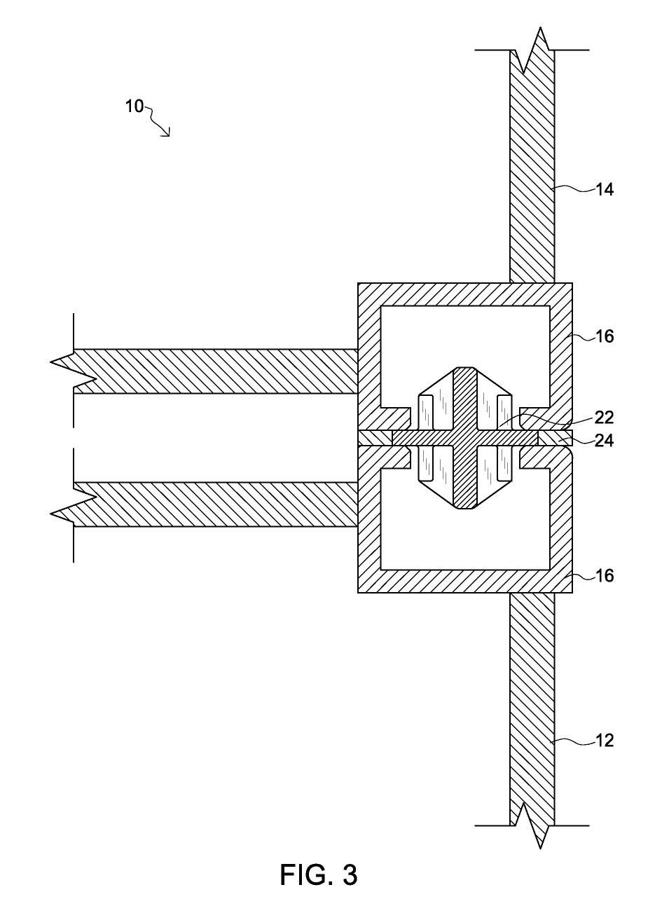

FIG. 3 is a partial side elevational view of a stacked shipping container assembly, according to one embodiment of the invention. There is shown a stacked shipping container assembly 10 including a bottom shipping container 12, a top shipping container 14, a stacking cone 22, and a toroidal weld plate 24. This illustration shows the assembly in a pre-welded state.

The illustrated stacked shipping container assembly 10 includes a bottom shipping container 12 having a corner blocks 16 at top corner thereof. The stacked shipping container assembly 10 includes a top shipping container 14 having a corner block 16 at a bottom corner thereof. The top shipping container 14 is stacked on the bottom shipping container 12 wherein the illustrated corner blocks 16 of each of the bottom shipping container 12 and the top shipping container 14 are aligned horizontally with each other.

The stacked shipping container assembly 10 includes a stacking cone 22 disposed between horizontally aligned pairs of corner blocks 16. The stacking cone 22 is configured to rest within a hole or aperture of each corner block 16, thereby aligning the top shipping container 14 with the bottom shipping container 12 for storage or transportation. The assembly 10 includes a toroidal weld plate 24 each disposed around a corresponding stacking cone 22 and between horizontally aligned pairs of corner blocks 16, thus automatically providing vertical alignment of the two shipping containers as the vertical freedom of motion is restricted by the space held by the weld plate. Without the weld plate, the two shipping containers have more horizontal freedom to shift and move about in horizontal relation to each other. The weld plate provides a solid and secure platform on which the top shipping container rests and maintains a more limited range of motion for the same. This is further limited once a weld is placed across the weld plate and adjacent corner blocks.

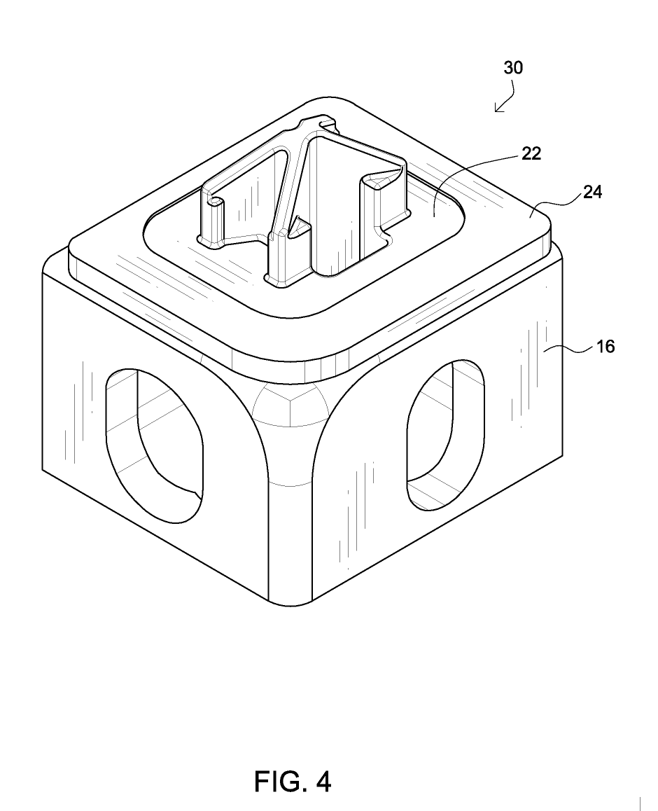

FIG. 4 is a perspective view of a shipping container stacking kit in place coupled to a corner block, according to one embodiment of the invention. In particular, there is shown a shipping container stacking kit 30 including a stacking cone 22 and a toroidal weld plate 24 coupled to a corner block 16 of a shipping container. Such a kit may also include instructions (e.g. in the form of a laminated chart/guide) and/or a list of suitable containers/container-types with which the kit may be used. Further, the kit may include appropriate packaging to keep portions of the kit together, safe, protected from elements and the like. There may also be one or more indicators with the kit and/or on the stacking cone and/or the flange that may indicate to an installer one or more characteristics (e.g. preferred orientations, relative orientations, stacking limits) of the kit and/or of elements of the kit that may be relevant in the method of use thereof.

The illustrated shipping container stacking kit 30 is configured to enable a plurality of shipping containers to be accurately coupled together. The kit 30 includes a stacking cone 22 having top and bottom connectors opposite each other and each shaped to penetrate a corner block hole. The stacking cone 22 includes a medial region coupling the top connector to the bottom connector. The kit 30 also includes a toroidal weld plate 24 having an inner hole shaped and sized to receive the medial region of the stacking cone 22. As illustrated the toroidal weld plate 24 includes exterior sides shaped and sized to be flush with exterior sides of standard shipping container corner blocks 16. The illustrated weld plate has flat top and bottom surfaces to smoothly abut the corner blocks.

FIG. 5 is an exploded view of a shipping container stacking kit, according to one embodiment of the invention. There is shown a shipping container stacking kit 30 including a stacking cone 22 and a toroidal weld plate 24 coupled to a corner block 16 of a shipping container.

The illustrated shipping container stacking kit 30 includes a stacking cone 22 having a top connector 32 shaped to penetrate a corner block hole 34. The stacking cone 22 includes a bottom connector 36 shaped to penetrate a corner block hole 34. The stacking cone 22 includes a medial region 38 coupling the top connector 32 to the bottom connector 36. The kit 30 includes a toroidal weld plate 24 having an inner hole 40 shaped and sized to receive the medial region 38 of the stacking cone 22. The illustrated toroidal weld plate 24 includes flat top and bottom surfaces. The illustrated top and bottom connectors 32, 36 are pyramidal shaped. The illustrated inner hole 40 of the toroidal weld plate 24 is disposed substantially off-center to the toroidal weld plate 24 such that the weld plate may advantageously abut the outside edges of the corner block and provide greater strength about the outside edge thereof while having a reduced total profile and weight.

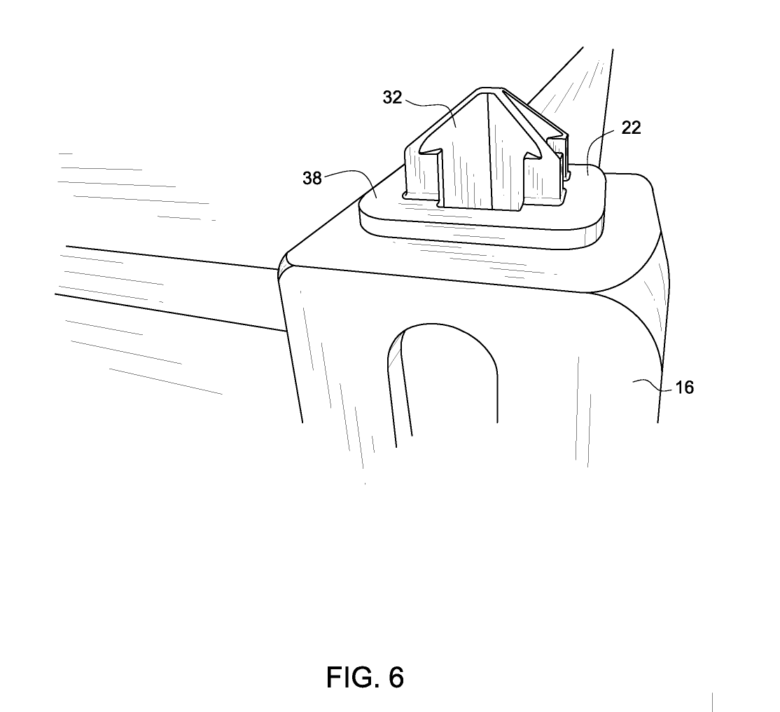

FIG. 6 is a perspective view of a stacking cone coupled to a shipping container, according to one embodiment of the invention. There is shown a stacking cone 22 coupled to a corner block 16 of a shipping container.

The illustrated stacking cone 22 is configured to rest within a corner block 16 of a shipping container to aid in stabilizing and securing another shipping container on top thereof. The stacking cone 22 includes a top connector 32 shaped to penetrate a corner block hole. The stacking cone 22 includes a medial region 38 coupling the top connector 32 to a bottom connector. The illustrated top connector 32 is pyramidal shaped.

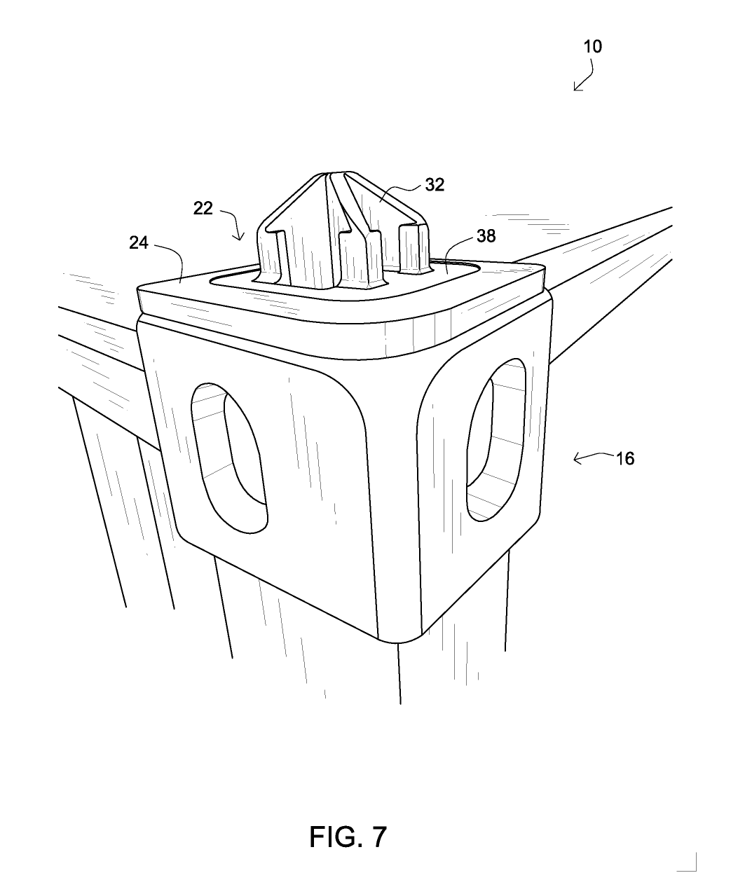

FIG. 7 is a perspective view of a toroidal weld plate and a stacking cone coupled to a shipping container, according to one embodiment of the invention. There is shown a shipping container stacking assembly 10 including a stacking cone 22 and a toroidal weld plate 24.

The illustrated stacking cone assembly 10 includes a stacking cone 22 having a top connector 32 shaped to penetrate a corner block hole of a shipping container. The stacking cone 22 also includes a medial region 38 coupling the top connector 32 to a bottom connector. The assembly 10 includes a toroidal weld plate 24 having an off-center inner hole shaped and sized to receive a medial region of the stacking cone 22 and including flat top and bottom surfaces, thereby abutting the outside edges of the adjacent illustrated corner block. The plate 24 is disposed about the medial region 38 of the stacking cone 22. The illustrated toroidal weld plate 24 includes exterior sides shaped and sized to be flush with exterior sides of standard shipping container corner blocks 16. The toroidal weld plate 24 may be welded to a pair of adjacent corner blocks of stacked shipping containers.

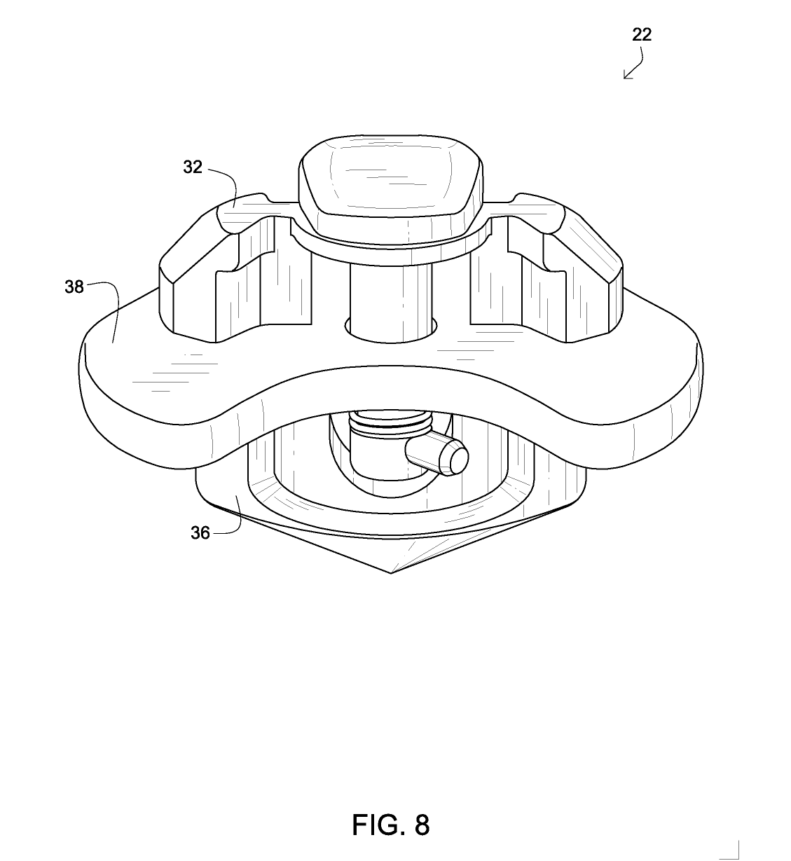

FIG. 8 is a perspective view of a stacking cone, according to one embodiment of the invention. There is shown a stacking cone 22 including a top connector 32, a medial region 38, and a bottom connector 36.

The illustrated stacking cone 22 is configured to rest within a corner block of a shipping container, wherein a toroidal weld plate is configured to rest around the stacking cone during use of stacking shipping containers. The stacking cone 22 includes a top connector 32 shaped to penetrate a corner block hole of a shipping container. The stacking cone 22 also includes a bottom connector 36 shaped to penetrate a corner block hole of a shipping container. The stacking cone 22 includes a medial region 38 coupling the top connector 32 to the bottom connector 36. The top and bottom connectors 32, 36 are pyramidal shaped.

FIG. 9 is a top plan view of a toroidal weld plate, according to one embodiment of the invention. There is shown a toroidal weld plate 24 having an inner hole 40.

The illustrated toroidal weld plate 24 is configured to rest around a stacking cone to aid in securing a shipping container stacked upon another shipping container. The toroidal weld plate 24 includes an inner hole 40 shaped and sized to receive a medial region of a stacking cone. The toroidal weld plate 24 includes flat top and bottom surfaces. The toroidal weld plate 24 includes exterior sides shaped and sized to be flush with exterior sides of standard shipping container corner blocks. The inner hole of the toroidal weld plate 24 is disposed substantially centered to the toroidal weld plate 24. The toroidal weld plate 24 may be welded to a pair of adjacent corner blocks of stacked shipping containers.

According to one embodiment of the invention, the toroidal weld plate positions a stacking cone in the precise location on top of a corner block of a shipping container, so that when the next container is stacked upon the lower container, the containers will perfectly line up on a vertical axis to allow for immediate welding of the corner blocks together with no offset.

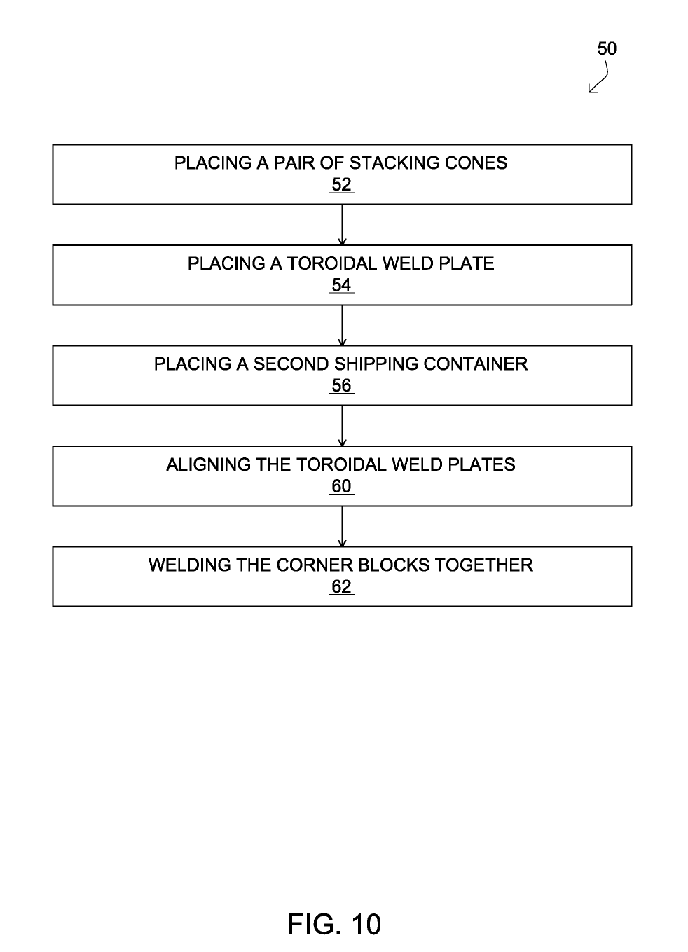

FIG. 10 is a flow chart of a method of stacking shipping containers, according to one embodiment of the invention. There is shown a method of stacking shipping containers 50.

The illustrated method of stacking shipping containers 50 includes the step of placing a pair of stacking cones each disposed between horizontally aligned pairs of corner blocks of a first shipping container 52. Generally, this step is accomplished by placing a first shipping container in place, such as but not limited to on a foundation, on another shipping container, or otherwise in a desired location, then placing a stacking cone in each of two (or more) corner blocks such that the stacking cones penetrate the holes thereof and are mated thereto. In the general use of stacking cones, the second shipping container is then placed over the first such that corner blocks are mated to the stacking cones.

However, the method of stacking shipping containers also includes the step of placing a toroidal weld plate about each of the pair of stacking cones and on top of the pairs of corner blocks 54. Generally, once the stacking cones are in place, the weld plates are then placed over and about the stacking cones and may be checked for proper installation and/or alignment. In particular, the assembly to this point may be checked to make sure that each pair of the stacking cone, weld plate and corner block are properly mated and that debris or other material is not interfering with the proper placement and relational positioning thereof.

According to one embodiment of the invention, the weld plates may be tack welded to the corner blocks before the placement of the second shipping container thereon; thereby securing the weld plate and the stacking cone to the corner block for stabilization of the structure before placing the second shipping container thereon.

The method 50 also includes placing a second shipping container over the stacking cones such that the stacking cones penetrate into holes of corner blocks of the second shipping container 56. Again, proper alignment is important, though the stacking cones and/or weld plates facilitate this alignment, and if free of debris and properly installed before lowering the second shipping container over the stacking cones, will generally self-align as desired. Generally the second shipping container is lowered using a crane or hoist structure. If there is not complete overlap of the second shipping container over the first shipping container, some other structure may need to be in place, such as but not limited to another shipping container, so that the second shipping container may properly rest thereon.

The method 50 includes the step of aligning the toroidal weld plates with outer edges of their respective corner blocks 62. Such may be accomplished in a manner similar to aligning the second shipping container, inasmuch as the structures themselves will generally self-align to within a desired degree or close thereto and final alignments may be made by hand, tool, device or machine before and/or after fully lowering the second shipping container and/or the full weight thereof onto the first shipping container. It is desired that the weld plate be in a position such that (based on the type of weld to be performed) the weld may be easily accomplished in a manner that provides for a strong weld across the weld plate and between the adjacent corner blocks. Various types of welding (arc, gas, resistance, energy beam, solid state and the like and combinations thereof) may require and/or prefer diverse positioning of the weld plate. As non-limiting examples, one type of welding may require that the weld plate be flush with the outside edges of the corner blocks to within 1/16 of an inch, while another type of welding may require that the weld plate be inset from flush at least ⅛ of an inch with the outside edges of the corner blocks.

The method of stacking shipping containers 50 includes the step of welding the corner blocks together via the toroidal weld plates 64. This is generally accomplished by acute heating of the materials to be welded together, usually together with a filler material (e.g. a consumable steel rod), by causing coalescence. Once welded, the corner blocks are each coupled strongly to the adjacent weld plate and thereby to each other.

The method of stacking shipping containers may be repeated to produce structures of varying heights and/or numbers of floors/stories, and thereby includes the steps of placing a pair of stacking cones each disposed between horizontally aligned pairs of top corner blocks of the second shipping container; placing a toroidal weld plate about each of the pair of stacking cones and on top of the pairs of corner blocks; placing a third shipping container over the stacking cones such that the stacking cones penetrate into holes of corner blocks of the third shipping container; and welding the corner blocks together via the toroidal weld plates.

According to one embodiment of the invention, the method of stacking shipping containers does not include the step of leveling the second shipping container with respect to the first shipping container. The stacking cone assembly is configured to align and level the shipping containers together for transportation. Such steps may not be included in the method: making minor adjustments by hand, tool or machine to the exact placement of the second shipping container either before or after fully lowering the second shipping container and/or the full weight thereof onto the first. Such tools may include hammers, forms, jackhammer type devices (motorized/powered striking systems), winches, jacks and the like and combinations thereof.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the illustrated weld plate is an irregular rectangular toroid, it is understood that more regularly shaped toroidal structures, including weld plates of actual toroid shape (doughnut shaped, e.g. an annular shape generated by revolving a plane geometric figure about an axis external to that figure which is parallel to the plane of the figure and does not intersect the figure) may be used herewith to varying degrees of benefits.

Additionally, although the figures illustrate two variations of stacking cones, it is understood that there are numerous various stacking cones currently on the market and still more in development that include the medial region and with which a flange/weld plate as described herein would interoperate if shaped and sized appropriately, even including stacking cones that include more complicated features, such as locking/latching mechanisms.

It is expected that there could be numerous variations of the design of this invention. An example is that the corner blocks may be placed in locations other than the corners of the shipping containers and/or that stacked shipping containers may be stacked in manners other than one shipping container resting entirely over another (e.g. stacked containers may only partially overlap).

Finally, it is envisioned that the components of the device may be constructed of a variety of materials, including but not limited to metals, plastics, gums, resins, ceramics, woods, fibers, woven fibers, composites and the like and combinations thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A stacked shipping container assembly, comprising:
a. a bottom shipping container having a plurality of corner blocks at top corners thereof;
b. a top shipping container having a plurality of corner blocks at bottom corners thereof and stacked on the bottom shipping container wherein at least two of the corner blocks of each of the bottom shipping container and the top shipping container are aligned horizontally with each other;
c. a pair of stacking cones each disposed between horizontally aligned pairs of corner blocks; and
d. a pair of toroidal weld plates, each disposed around a corresponding stacking cone and between horizontally aligned pairs of corner blocks.

2. The assembly of claim 1, wherein the pair of toroidal weld plates are of substantially the same height.

3. The assembly of claim 1, further comprising a weld fixedly coupling aligned corner blocks to their associated weld plates.

4. The assembly of claim 1, wherein the pair of toroidal weld plates have flat top and bottom surfaces.

5. The assembly of claim 1, wherein the pair of toroidal weld plates have exterior sides shaped and sized to be flush with exterior sides of corresponding corner blocks.

6. The assembly of claim 1, wherein the pair of stacking cones are pyramidal shaped.

7. The assembly of claim 1, wherein the stacking cones each rest within the corresponding corner block.

8. A shipping container stacking kit, comprising
a. a stacking cone having a top connector shaped to penetrate a corner block hole, a bottom connector shaped to penetrate a corner block hole and a medial region coupling the top connector to the bottom connector; and
b. a toroidal weld plate having an inner hole shaped and sized to receive the medial region of the stacking cone.

9. The kit of claim 8, wherein the toroidal weld plate has flat top and bottom surfaces.

10. The kit of claim 8, further comprising a second stacking cone and an associated second toroidal weld plate.

11. The kit of claim 8, wherein the toroidal weld plate has exterior sides shaped and sized to be flush with exterior sides of standard shipping container corner blocks.

12. The kit of claim 8, wherein top and bottom connectors are pyramidal shaped.

13. The kit of claim 8, wherein the inner hole of the toroidal weld plate is disposed substantially off-center to the toroidal weld plate.

14. A method of stacking shipping containers, comprising the steps of:
a. placing a pair of stacking cones each disposed between horizontally aligned pairs of corner blocks of a first shipping container;
b. placing a toroidal weld plate about each of the pair of stacking cones and on top of the pairs of corner blocks;
c. placing a second shipping container over the stacking cones such that the stacking cones penetrate into holes of corner blocks of the second shipping container; and
d. welding the corner blocks together via the toroidal weld plates.

15. The method of claim 14, further comprising aligning the toroidal weld plates with outer edges of their respective corner blocks.

16. The method of claim 14, further comprising:
a. placing a pair of stacking cones each disposed between horizontally aligned pairs of top corner blocks of the second shipping container;
b. placing a toroidal weld plate about each of the pair of stacking cones and on top of the pairs of corner blocks;
c. placing a third shipping container over the stacking cones such that the stacking cones penetrate into holes of corner blocks of the third shipping container; and
d. welding the corner blocks together via the toroidal weld plates.

17. A stacking cone assembly, consisting of:
a. a stacking cone having a top connector shaped to penetrate a corner block hole, a bottom connector shaped to penetrate a corner block hole and a medial region coupling the top connector to the bottom connector; and
b. a toroidal weld plate having an off-center inner hole shaped and sized to receive the medial region of the stacking cone and having flat top and bottom surfaces, the plate being disposed about the medial region of the stacking cone.

18. The assembly of claim 17, wherein the toroidal weld plate has exterior sides shaped and sized to be flush with exterior sides of standard shipping container corner blocks.

19. The assembly of claim 18, wherein the toroidal weld plate is welded to a pair of adjacent corner blocks of stacked shipping containers.
